(19) United States
(12) Patent Application Publication
(10) Pub. No.: US 2012/0314241 A1
(43) Pub. Date: Dec. 13, 2012

(54) IMAGE PROCESSING APPARATUS, METHOD OF CONTROLLING THE SAME AND STORAGE MEDIUM

(75) Inventor: Hiroshi Uchikawa, Yokohama-shi (JP)

(73) Assignee: CANON KABUSHIKI KAISHA, Tokyo (JP)

(21) Appl. No.: 13/480,868

(22) Filed: May 25, 2012

(30) Foreign Application Priority Data
Jun. 8, 2011 (JP) 2011-128642

(51) Int. Cl. G06K 15/02

(52) U.S. Cl. 358/1.14

(57) ABSTRACT

This invention provides an image processing apparatus that dynamically changes the display priority of a web browser in accordance with a user authentication state, a method of controlling the same, and a program. To accomplish this, the image processing apparatus sets the display priority of the web browser when it is determined that a user has not been authenticated to be higher than the display priority when it is determined that the user has been authenticated.

### BACKGROUND OF THE INVENTION

1. Field of the Invention

The present invention relates to an image processing apparatus, a method of controlling the same, and a storage medium.

2. Description of the Related Art

Recent multi functional peripherals often implement applications such as scan and print by accessing a web server using a preinstalled web browser and cooperating with a server application. This implementation form is considered to be more popular along with the growth of the functionality of multi functional peripherals because there is no need to install the applications in the individual multi functional peripherals, and installing the applications in the web server suffices, bringing about significant advantages from the viewpoint of TCO.

In such a use case, a web application customized for the customer environment of the installation destination is operated on a web browser. The user operation is basically complete on the web browser. However, there is also a demand for using both the web application and an application preinstalled in the multi functional peripheral to use a general function that needs no customization. In this case, from the viewpoint of operability, it is important to seamlessly implement the operation on the web browser and the operation of the application installed in the multi functional peripheral.

User authentication for the multi functional peripheral is also demanded to be concentratedly managed on the web server instead of using a login screen preinstalled in the multi functional peripheral, as a matter of course. In this case, the web browser serving as a general-purpose content display mechanism needs to have the function of displaying the login screen on the multi functional peripheral. For example, Japanese Patent Laid-Open No. 2007-087399 proposes a method of displaying an external authentication application on the uppermost layer of the screen of a multi functional peripheral so as to control access.

However, the related art has the following problems. A general multi functional peripheral sometimes displays various screens automatically in accordance with its state such as paper out or paper jam without user operations. For this reason, when operated in a mode requiring user authentication, the window management mechanism of the multi functional peripheral limits access by controlling such that the screen of a function that needs user authentication is not displayed in a user unauthenticated state.

Hence, in the arrangement for causing the web server to concentratedly manage user authentication of the multi functional peripheral, as described above, the window display priority of the web browser serving as a general-purpose content display mechanism needs to be controlled in accordance with the user authentication state. That is, it is necessary to control to display, in a user unauthenticated state, neither a web application that should be made usable only after user authentication nor an application preinstalled in the multi functional peripheral, but a web application for login that should be displayed before authentication.

### SUMMARY OF THE INVENTION

The present invention enables realization of an image processing apparatus that dynamically changes the display priority of a web browser in accordance with a user authentication state, a method of controlling the same, and a storage medium.

One aspect of the present invention provides an image processing apparatus including a web browser that displays a screen based on screen information provided by a web server, comprising: a determination unit that determines whether or not a user of the image processing apparatus has been authenticated; and a setting unit that sets a display priority of the web browser when the determination unit has determined that the user has not been authenticated to be higher than the display priority when the determination unit has determined that the user has been authenticated.

Another aspect of the present invention provides a method of controlling an image processing apparatus including a web browser that displays a screen based on screen information provided by a web server, comprising: determining whether or not a user of the image processing apparatus has been authenticated; and setting a display priority of the web browser when it is determined in the determining that the user has not been authenticated to be higher than the display priority when it is determined in the determining that the user has been authenticated.

Still another aspect of the present invention provides a computer-readable storage medium storing a computer program that causes a computer to execute a method of controlling the image processing apparatus.

Further features of the present invention will be apparent from the following description of exemplary embodiments with reference to the attached drawings.

### BRIEF DESCRIPTION OF THE DRAWINGS

FIG. 1 is a schematic view showing the arrangement of a system including an image processing apparatus according to the embodiment;

FIG. 2 is a block diagram showing the hardware arrangement of the image processing apparatus according to the embodiment;

FIG. 3 is a block diagram showing the software configuration of the image processing apparatus according to the embodiment;

FIG. 4 is a view showing a screen to set a web authentication mode according to the embodiment;

FIGS. 5A and 5B are sequence charts showing a login & window priority switching process according to the embodiment;

FIG. 6 is a view showing the window priority before and after user login according to the embodiment; and

FIG. 7 is a flowchart showing a login & window priority switching process according to the embodiment.

### DESCRIPTION OF THE EMBODIMENTS

Embodiments of the present invention will now be described in detail with reference to the drawings. It should be noted that the relative arrangement of the components, the numerical expressions and numerical values set forth in these embodiments do not limit the scope of the present invention unless it is specifically stated otherwise.

<System Arrangement>

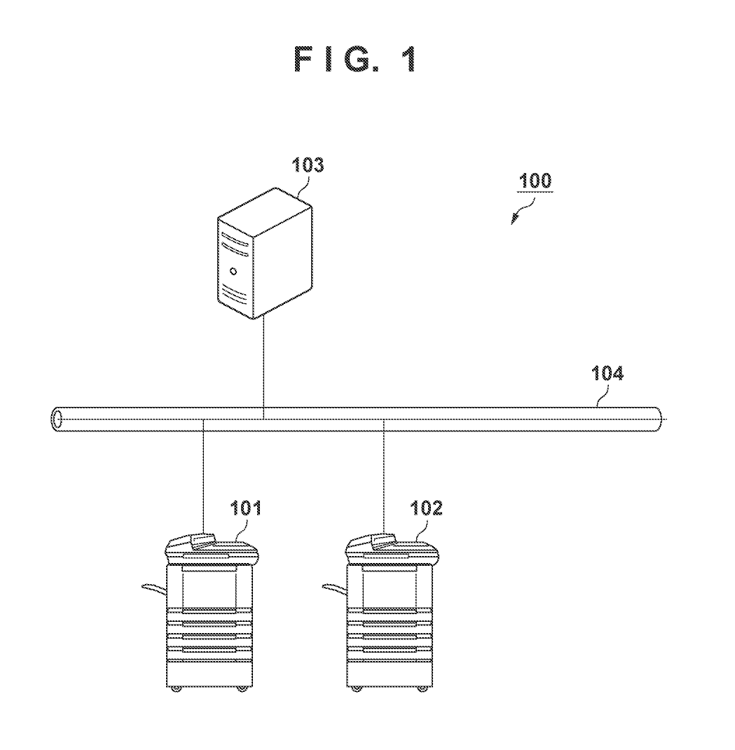

A system arrangement including an image processing apparatus according to the present invention will now be described with reference to FIG. 1. An image processing system 100 according to the embodiment includes image processing apparatuses 101 and 102 and a PC (Personal Computer) 103, which are connected via a network. In this embodiment, the image processing apparatuses 101 and 102 and the PC 103 are connected via Ethernet® 104. However, this is merely an example of the system. For example, the web server function of the PC 103 may be imparted to the image processing apparatus 101, and the system may include only the image processing apparatus 101.

The image processing apparatus 101 is a multi functional peripheral which has not only a function of displaying a screen on a display unit using screen information held in it in advance but also a web browser function of displaying, on the display unit, an external content provided by the PC 103. In addition, the image processing apparatus 101 has not only a function of copying a paper document but also a function of printing print data sent from an external printer driver and a function (SEND function) of reading a paper document and sending the data to an external file server or a mail address. The image processing apparatus 101 also has a function (remote copy function and facsimile function) of sending data to the other image processing apparatus 102 and causing the image processing apparatus 102 of the sending destination to print the data and a function of accessing the PC 103 and displaying various web pages (to be described later). The PC 103 is a server PC serving as a web server that returns, in response to a web page acquisition request from the image processing apparatus 101, HTML data (screen information) constructing a web page to the image processing apparatus 101.

<Hardware Arrangement of Image Processing Apparatus>

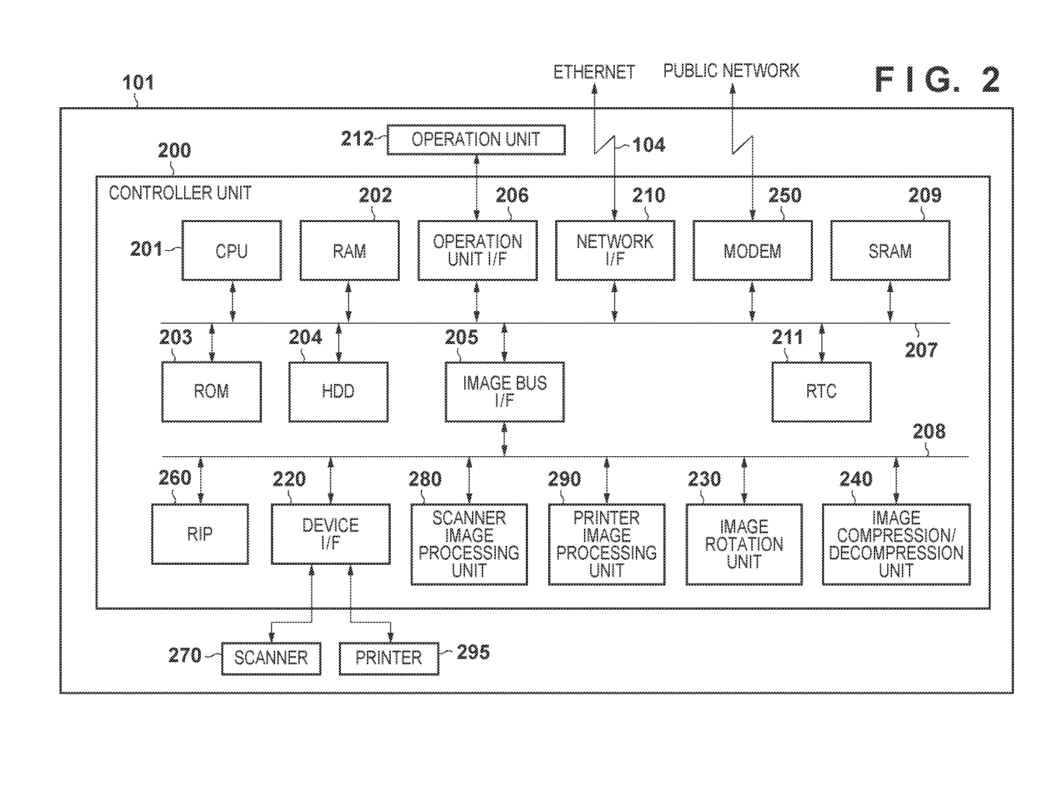

The hardware arrangement of the image processing apparatus 101 will be described next with reference to FIG. 2. Note that the image processing apparatus 102 has the same arrangement as that of the image processing apparatus 101 to be described below, and a description thereof will be omitted. The image processing apparatus 101 includes a controller unit 200, an operation unit 212, a scanner 270, and a printer 295. The controller unit 200 includes a CPU 201, a RAM 202, a ROM 203, an HDD 204, an image bus I/F 205, an operation unit I/F 206, an SRAM 209, a network I/F 210, an RTC 211, a device I/F 220, an image rotation unit 230, an image compression/decompression unit 240, a modem 250, an RIP 260, a scanner image processing unit 280, and a printer image processing unit 290.

The controller unit 200 is connected to the scanner 270 serving as an image input device and the printer 295 serving as an image output device and also connected to the Ethernet® 104 and a public network so as to input/output image information and device information. The CPU 201 is a controller that controls the image processing apparatus 101. The RAM 202 serves as a system work memory to be used by the CPU 201 to operate and also serves as an image memory for temporarily storing image data. The ROM 203 is a boot ROM that stores the boot program of the system. The HDD 204 is a hard disk drive that stores system software, applications, and image data.

The operation unit I/F 206 is an interface unit for the operation unit 212 having a touch panel and outputs, to the operation unit 212, image data to be displayed on the display unit of the operation unit 212. The operation unit I/F 206 also acts to transmit information input by the system user via the operation unit 212 to the CPU 201. The network I/F 210 is connected to the Ethernet® 104 to input/output information. The modem 250 is connected to the public network to input/output information.

The SRAM 209 is a nonvolatile storage medium capable of operating at a high speed. The RTC 211 is a real-time clock that continuously counts the current time even if the controller unit 200 is in the power-off state. The above-described devices are arranged on a system bus 207.

The image bus I/F 205 is a bus bridge that connects the system bus 207 and an image bus 208 for transferring image data at a high speed so as to convert the data structure. The image bus 208 is formed from a PCI bus or IEEE1394. The above-described devices are arranged on the image bus 208.

The RIP 260 is a raster image processor which rasterizes a PDL code to a bitmap image. The device I/F 220 connects the scanner 270 and the printer 295, which serve as image input and output devices, to the controller unit 200 so as to perform conversion between a synchronous system and an asynchronous system of image data. The scanner image processing unit 280 corrects, manipulates, and edits input image data. The printer image processing unit 290 performs printer correction, resolution conversion, and the like for print output image data. The image rotation unit 230 rotates image data. The image compression/decompression unit 240 performs compression/decompression processing.

<Software Configuration of Image Processing Apparatus>

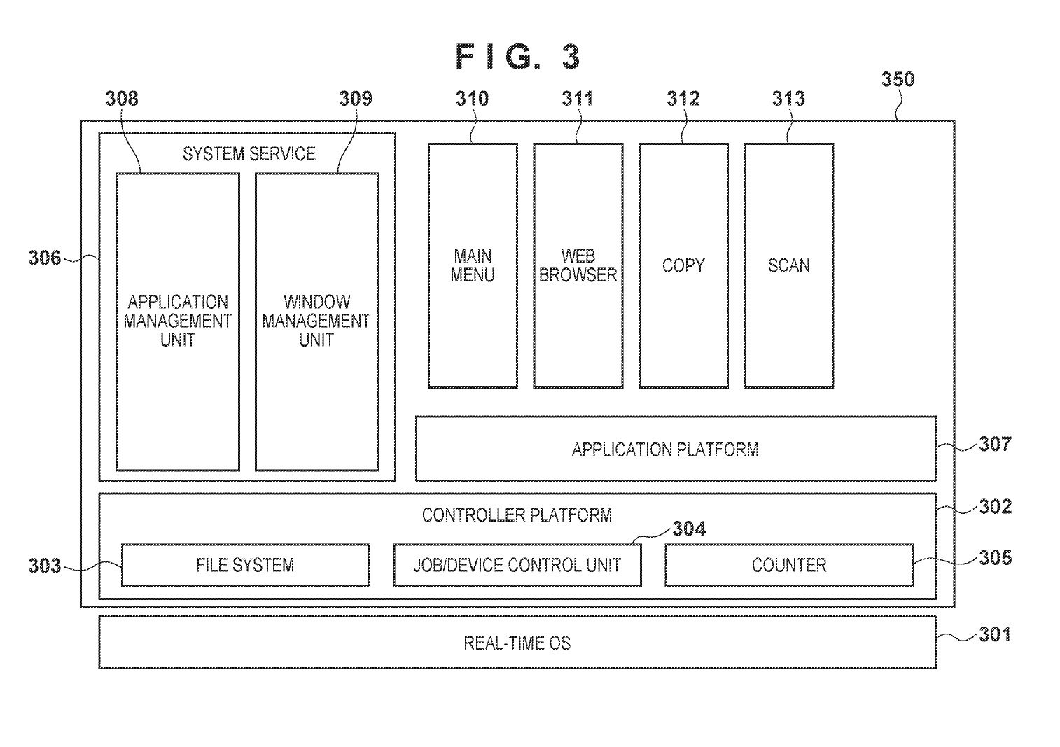

The software configuration of the image processing apparatus 101 according to this embodiment will be described next with reference to FIG. 3. This software is stored in the HDD 204 of the image processing apparatus 101 as so-called firmware 350, read out to the RAM 202, and executed by the CPU 201. The firmware 350 includes a controller platform 302, a system service 306, an application platform 307, a main menu 310, a web browser 311, a copy 312, and a scan 313. The controller platform 302 includes a file system 303, a job/device control unit 304, and a counter 305. The system service 306 includes an application management unit 308 and a window management unit 309.

A real-time OS 301 is a real-time operating system which provides services and schemes of various resource management optimized to control a built-in system for software that runs on it. The services and schemes of various resource management by the real-time OS 301 include multitask (thread) management for causing the CPU 201 to manage a plurality of process execution contexts and actually parallelly perform a plurality of processes and intertask communication for implementing synchronization between tasks and data exchange. Also included are memory management, interrupt management, and protocol stack that implements processes of various protocols of various device drivers, local interfaces, networks, and communications.

The file system 303 is a mechanism configured to store constructed data on a storage device such as the HDD 204 or the RAM 202. The job/device control unit 304 controls the hardware of the image processing apparatus 101 and also controls jobs that use basic functions (for example, print, scan, communication, and image conversion) provided mainly by the hardware of the image processing apparatus 101. The counter 305 manages the expiration date of each application and the count values of print and scan, which are stored in the SRAM 209.

The application management unit 308 is a management module configured to install, uninstall, activate, or stop the applications 310, 311, 312, 313, and the like. The window management unit 309 is a management module configured to control the display order of application windows of the applications 310, 311, 312, 313, and the like. The application platform 307 is middleware that makes the mechanisms of the real-time OS 301 and the controller platform 302 usable from the applications 310, 311, 312, 313, and the like.

Each of the applications 310, 311, 312, and 313 is application software that implements various business models using functions provided by the application platform 307. The main menu 310 has a menu function of selecting an application. The web browser 311 has a web browser function of browsing a web server. The copy 312 has a copy function of copying a paper document. The scan 313 has a scan function of reading a paper document and sending the data.

<Authentication Setting Screen>

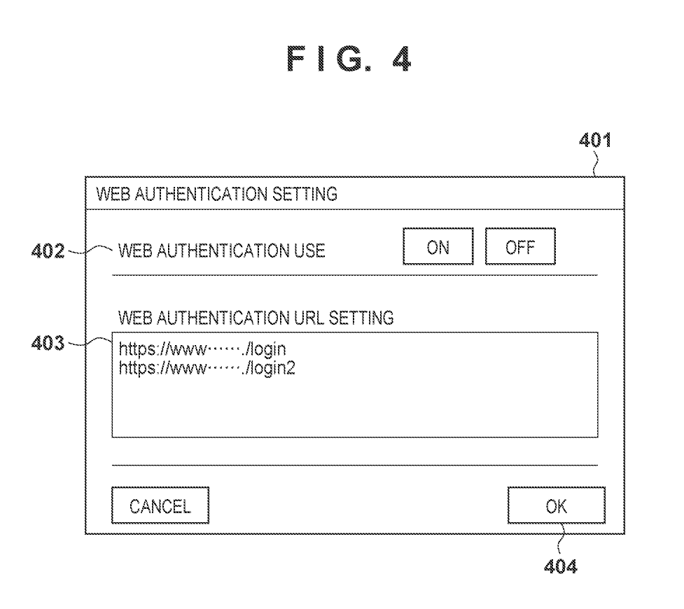

A screen to set a web authentication mode according to the embodiment will be described next with reference to FIG. 4. A web authentication mode setting screen 401 of this embodiment is output to the operation unit 212 by the window management unit 309. The window management unit 309 is stored in the HDD 204 of the image processing apparatus 101 as the firmware 350, read out to the RAM 202, and executed by the CPU 201.

The web authentication mode setting screen 401 displays the set value of web authentication use 402 and the set value of web authentication URL setting 403, which are recorded in the HDD 204. When the user sets the web authentication use 402 to ON, registers a URL (the address of the web server) in the web authentication URL setting 403, presses an OK 404, and reactivates the image processing apparatus 101, the image processing apparatus 101 operates in the web authentication mode. In this embodiment, a URL registered in the web authentication URL setting 403 is set as a URL capable of displaying the web browser even before login of the user. Access to a URL that is not set here is impossible before login. If a plurality of URLs are registered, the first URL is handled as an authentication URL.

<Priority Switching Process>

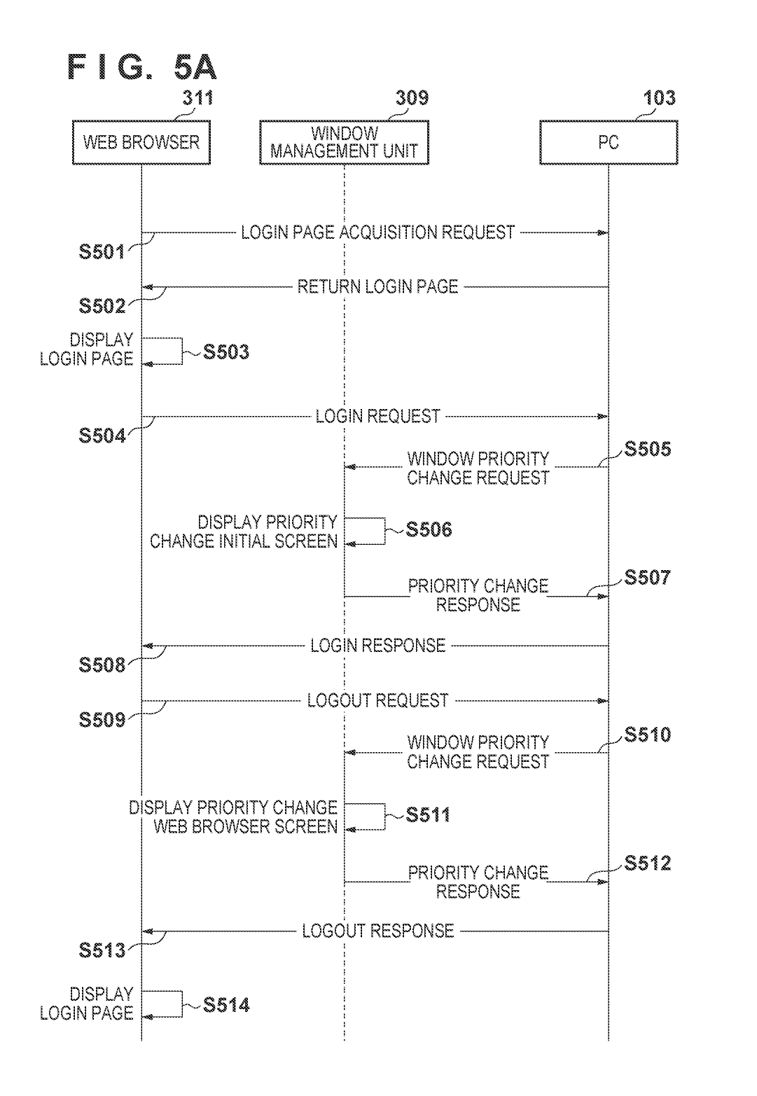

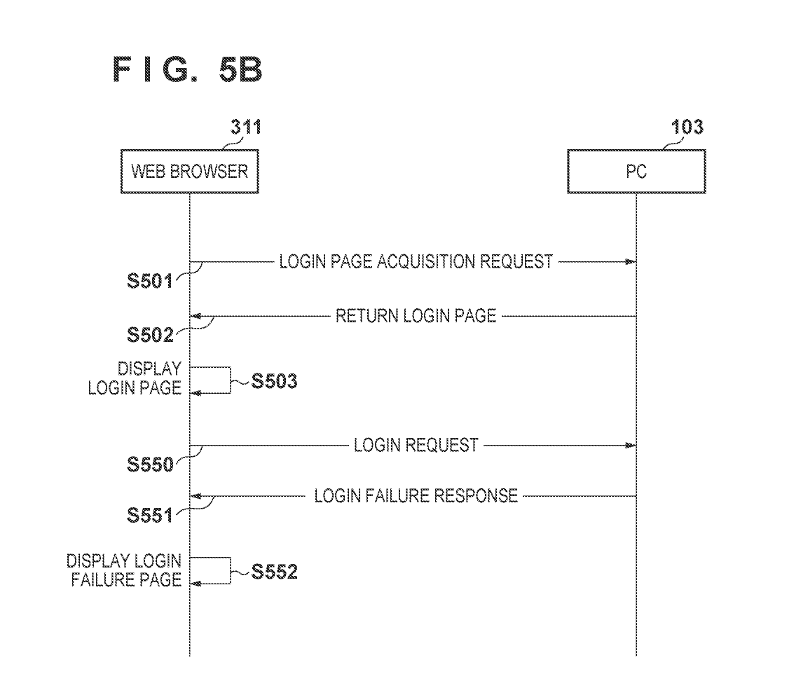

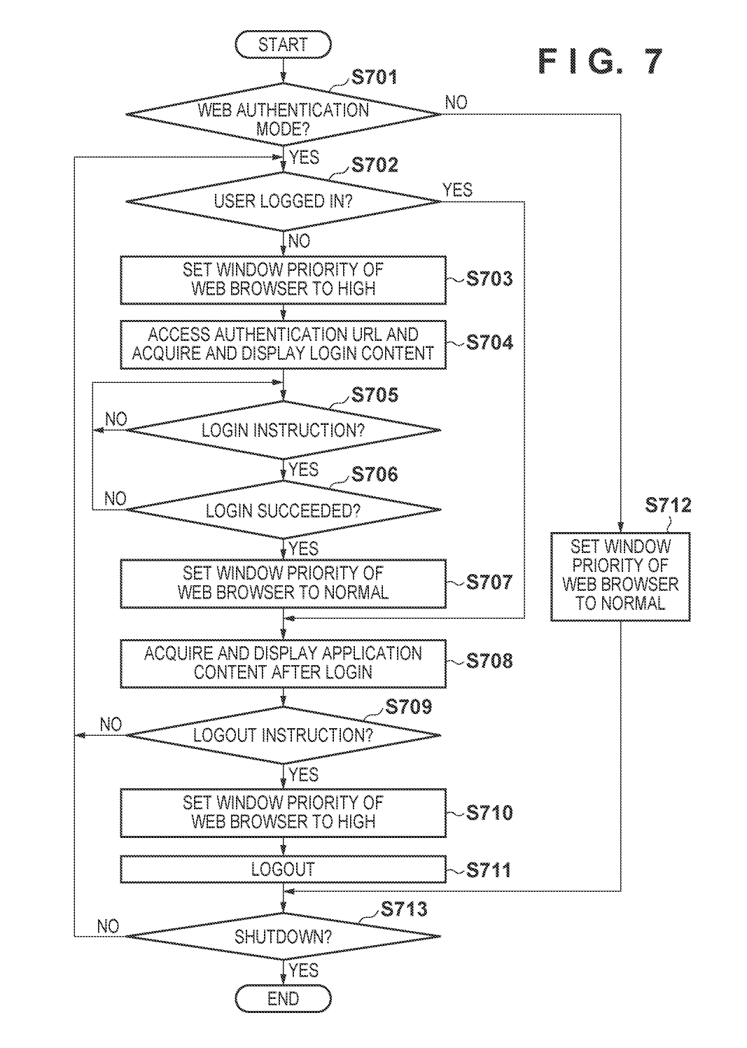

A login & window priority (a display priority) switching process according to the embodiment will be described next with reference to FIGS. 5A and 5B. The firmware 350 concerning window management according to the embodiment is stored in the HDD 204 of the image processing apparatus 101, read out to the RAM 202, and executed by the CPU 201. FIG. 5A shows a sequence for successful login. Control considering an actual login failure will be described later with reference to FIG. 7.

In step S501, the web browser 311 reads out the set value of the web authentication use 402. If the web authentication use 402 is ON, the web browser 311 also reads out the set value of the web authentication URL setting 403 and issues a login page acquisition request to the PC 103. In step S502, the PC 103 returns the screen information of the login page to the web browser 311. In step S503, the web browser 311 displays the acquired login page on the operation unit 212.

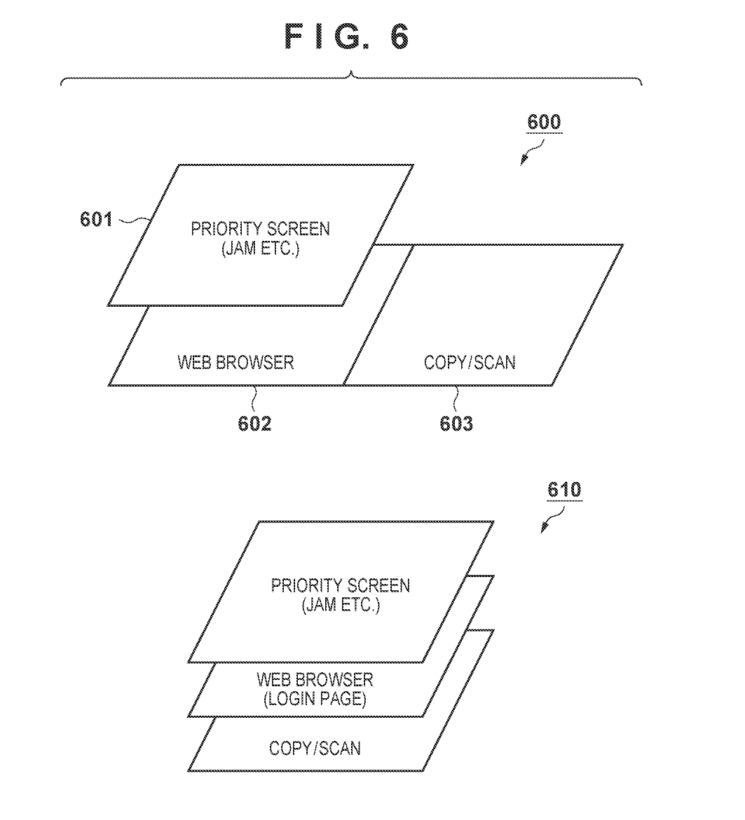

In step S504, the web browser 311 issues a login request to the PC 103 upon detecting a login instruction of the user. In step S505, the PC 103 analyzes information contained in the login request and, upon determining that the request is valid, issues a window priority change request to the window management unit 309. In step S506, the window management unit 309 changes the window priority of a web browser (first window) 602 to the same level as that of a general application such as copy/scan (second window) 603, as indicated by 600 in FIG. 6. In FIG. 6, the window shown on the upper side has a higher priority, and the windows juxtaposed are managed in the same priority. That is, 600 indicates that a priority screen 601 has a higher priority, and the web browser 602 and the copy/scan 603 have the same priority.

The window management unit 309 also switches the window to the initial screen to be displayed after login. In step S507, the window management unit 309 sends a priority change response to the PC 103. After receiving the priority change response received, the PC 103 sends a login response to the web browser 311 in step S508. The login process thus ends so as to enable access to applications usable after login.

Next, in step S509, the web browser 311 issues a logout request to the PC 103 upon detecting a logout instruction of the user. In step S510, the PC 103 issues a window priority change request to the window management unit 309. In step S511, the window management unit 309 changes the window priority of the web browser 602 to a level higher than that of a general application such as the copy/scan 603, as indicated by 610 in FIG. 6. In this case, 610 indicates that the priority screen 601 has the highest priority, the web browser 602 has the second highest priority, and the copy/scan 603 has the third highest priority. The window management unit 309 also switches the window (for example, login screen) to the web browser to be displayed after logout. In step S512, the window management unit 309 sends a priority change response to the PC 103. After receiving the priority change response received, the PC 103 sends a logout response to the web browser 311 in step S513. In step S514, the web browser 311 displays the login page.

A process to be executed when login has failed will be described next with reference to FIG. 5B. Note that the same step numbers as in FIG. 5A denote the same processes in FIG. 5B, and a description thereof will not be repeated here. That is, the description of the processes of steps S501 to S503 will be omitted.

After displaying the login page in step S503, the web browser 311 issues a login request to the PC 103 in step S550 upon detecting a login instruction of the user. In step S551, the PC 103 returns a login failure response to the web browser 311. In step S552, the web browser 311 displays a login failure page. As described above, according to this embodiment, if user login has failed, the window priority is not changed.

<Processing Procedure>

The processes of the window management unit 309 and the web browser 311 according to this embodiment will be described next with reference to FIG. 7. The window management unit 309 and the web browser 311 of this embodiment are stored in the HDD 204 of the image processing apparatus 101 as the firmware 350, read out to the RAM 202, and executed by the CPU 201.

In step S701, the window management unit 309 reads out the set value of the web authentication use 402 and determines whether the web authentication mode is set. If the set value is “OFF”, the window management unit 309 determines that the web authentication mode is not set, and the process advances to step S712. The window management unit 309 sets the display priority of the window of the web browser to “normal” independently of whether the user has logged in, and the process advances to step S713.

On the other hand, if the set value is “ON”, the window management unit 309 determines that the web authentication mode is set, and the process advances to step S702. The window management unit 309 determines whether the user has already logged in from the operation unit 212. If the user has logged in, the process advances to step S708 to be described later. If the user has not logged in, the process advances to step S703. The window management unit 309 sets the display priority of the window of the web browser to “high”.

In step S704, the web browser 311 reads out the web authentication URL setting 403, acquires a login page content from the corresponding URL, and displays it. In step S705, the web browser 311 determines whether a login instruction is received from the user. If no login instruction is detected, the determination of step S705 is repetitively periodically executed.

Upon detecting a login instruction, the process advances to step S706. The web browser 311 issues a login request to the PC 103 and determines a login response. If login has failed, the process returns to step S705. If login has succeeded, the process advances to step S707. The window management unit 309 sets the display priority of the window of the web browser to “normal”. In step S708, the web browser 311 acquires and displays various contents after login.

In step S709, the web browser 311 determines whether a logout instruction is received. If no logout instruction is detected, the process returns to step S702. Upon detecting a logout instruction, the process advances to step S710. The window management unit 309 sets the display priority of the window of the web browser to “high”. In step S711, the web browser 311 executes a logout process, and the process advances to step S713. In step S713, the web browser 311 determines whether a shutdown request is issued. If no shutdown request is issued, the process returns to step S702 to continue the process. If a shutdown request is issued, the process ends.

As described above, the image processing apparatus according to this embodiment changes, based on the user authentication state (before or after login), the priority of the window to be displayed. This enables control to display, in a user unauthenticated state, neither a web application that should be made usable only after user authentication nor an application preinstalled in the multi functional peripheral, but a web application for login that should be displayed before authentication.

### Other Embodiments

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (for example, computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2011-128642 filed on Jun. 8, 2011, which is hereby incorporated by reference herein in its entirety.

What is claimed is:

1. An image processing apparatus including a web browser that displays a screen based on screen information provided by a web server, comprising:
a determination unit that determines whether or not a user of the image processing apparatus has been authenticated; and
a setting unit that sets a display priority of the web browser when said determination unit has determined that the user has not been authenticated to be higher than the display priority when said determination unit has determined that the user has been authenticated.

2. The apparatus according to claim 1, wherein the image processing apparatus communicates with the web server via a network.

3. The apparatus according to claim 1, wherein said setting unit changes the display priority of the web browser in accordance with an instruction from the web server.

4. The apparatus according to claim 1, wherein said setting unit changes the display priority of the web browser in accordance with one of login and logout of the user.

5. The apparatus according to claim 1, wherein if the web browser is not used to authenticate the user, said setting unit does not change the display priority of the web browser when the user has not been authenticated and when it is determined that the user has not been authenticated.

6. The apparatus according to claim 5, further comprising a selection unit that selects, in accordance with a user instruction, whether to use the web browser to authenticate the user.

7. The apparatus according to claim 1, wherein the display priority of the web browser when said determination unit has determined that the user has not been authenticated is lower than the display priority of a screen indicating an error.

8. A method of controlling an image processing apparatus including a web browser that displays a screen based on screen information provided by a web server, comprising:
determining whether or not a user of the image processing apparatus has been authenticated; and
setting a display priority of the web browser when it is determined in the determining that the user has not been authenticated to be higher than the display priority when it is determined in the determining that the user has been authenticated.

9. A computer-readable storage medium storing a computer program that causes a computer to execute a method of controlling an image processing apparatus according to claim 8.
